(19) United States
(12) Patent Application Publication
(10) Pub. No.: US 2009/0302997 A1
(43) Pub. Date: Dec. 10, 2009

(54) Third-party access control

(76) Inventor: Alexandre Bronstein, Ramat Bet Shemesh (IL)

Correspondence Address: PAUL H. HORSTMANN, 5440 Tujunga AVE #1009, North Hollywood, CA, 91601, US

(21) Appl. No.: 12/156,757

(22) Filed: Jun. 4, 2008

(51) Int. Cl. G05B 19/00; G08C 19/00

(52) U.S. Cl. 340/5.54; 340/5.2

(57) ABSTRACT

Techniques for third-party access control include performing a communication to a third-party in response to an attempt by an individual to access an object. A control input from the third-party is obtained using the communication and a determination is made whether to allow the individual to access the object in response to the control input.

### BACKGROUND

It may be desirable under a variety of circumstances to enable a third-party to control access to an object. For example, a parent may wish to control access to a web site by their children. In another example, an employer may wish to control access to files, records, secure areas, etc., by their employees.

Prior methods for providing third-party access control include maintaining lists. For example, a parent may employ computer software that maintains a list of approved web sites and that prevents an access to a web site unless the web site is on the list of approved web sites. In another example, an employer may use security badges or pass codes to control access to secure areas of buildings.

Unfortunately, such prior methods may not provide flexible third-party access control. For example, the goals and desires and knowledge of a parent can quickly change over time and access control lists may not have up to date information. In addition, maintaining and updating access control lists can impose an additional burden. Similarly, an employer may wish to grant an employee access to a secure area at some times but not at others without having to go through the overhead process of changing security codes or access control lists.

### SUMMARY OF THE INVENTION

Techniques for third-party access control are disclosed that include performing a communication to a third-party in response to an attempt by an individual to access an object. A control input from the third-party is obtained using the communication and a determination is made whether to allow the individual to access the object in response to the control input.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates third-party access control according to the present techniques in which an access controller enables a third-party to control access by an individual to an object;

FIG. 2 shows an embodiment in which the object is a web site that is accessible via the (world-wide) web;

FIG. 3 shows an embodiment in which the object is a database and an access controller is implemented in a server for the database;

FIG. 4 shows an embodiment in which the object is an application program that runs under an operating system of a computer;

FIG. 5 shows an embodiment in which the object is a physical object;

FIG. 6 shows an embodiment in which some of the functions of an access controller are performed by an access control server.

### DETAILED DESCRIPTION

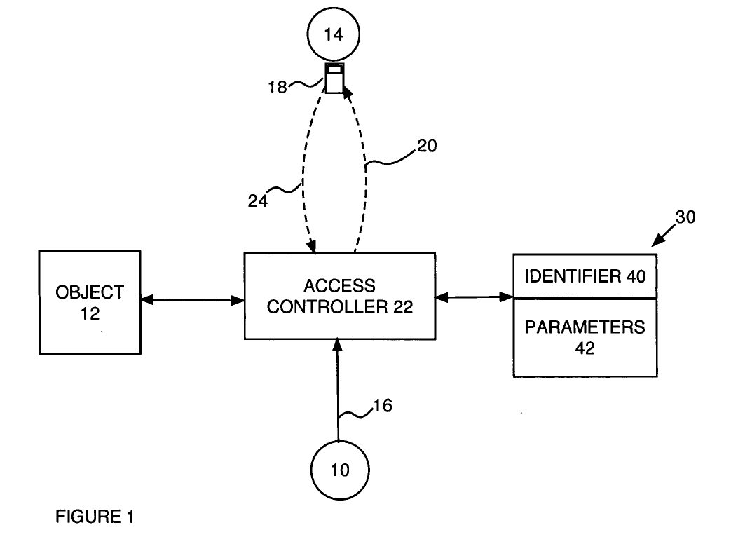

FIG. 1 illustrates third-party access control according to the present techniques in which an access controller 22 enables a third-party 14 to control access by an individual 10 to an object 12. The object 12 may be a virtual object or a physical object. Examples of virtual objects include application programs, files, web sites, web games, databases, records or tables within databases, etc. Examples of physical objects include buildings, areas within buildings, vehicles, safes, secure areas, etc.

In response to an attempt 16 by the individual 10 to access the object 12 the access controller 22 performs a communication 20 to the third-party 14. The access controller 22 then obtains a control input 24 from the third-party 14. The access controller 22 uses the control input 24 to determine whether or not to allow the individual 10 to access the object 12.

The communication 20 may be any type of communication that enables the third-party 14 to provide a timely approval or disapproval of the attempt 16 by individual 10 to access the object 12. The communication 20 may be a call or SMS message to a cell phone 18 or other wireless device possessed by the third-party 14. It may be likely that the third-party 14 is in possession of such a device so that the likelihood of unreasonable delays may be avoided.

The control input 24 may be a voice input or other type of input, e.g. an alphanumeric string entered via a keypad of the cell phone 18 or other device possessed by the third-party 14. The control input 24 may be provided by the third-party 14 in response to a prompt from the access controller 22. For example, the third-party 14 may say “yes” as the control input 24 in response to a prompt of “Is it ok to grant access to a computer game?” generated by the access controller 22 during the communication 20. The prompt may be a voice prompt or a text prompt, e.g. via a text message. The control input 24 may be a password in voice or alphanumeric form.

The access controller 22 performs its functions in accordance with a set of settings 30. The settings 30 may be provided by the third-party 14. The settings 30 include a communication channel identifier 40 and a set of parameters 42. The communication channel identifier 40 specifies a phone number, email address, etc., for use in the communication 20 to the third-party 14. The parameters 42 may include any number of parameters that the third-party 14 may use to describe conditions that will cause the access controller 22 to perform the communication 30. The parameters 42 may include an identifier for the individual 10, e.g. by login name, real name, badge number, employee number, etc., so that the access controller 22 may recognize the attempt 16. The parameters 42 may include an identifier for the object 12, e.g. by web address, application name, database name, record name, building identifier, room number, vehicle identifier, etc., so that the access controller 22 may recognize the attempt 16.

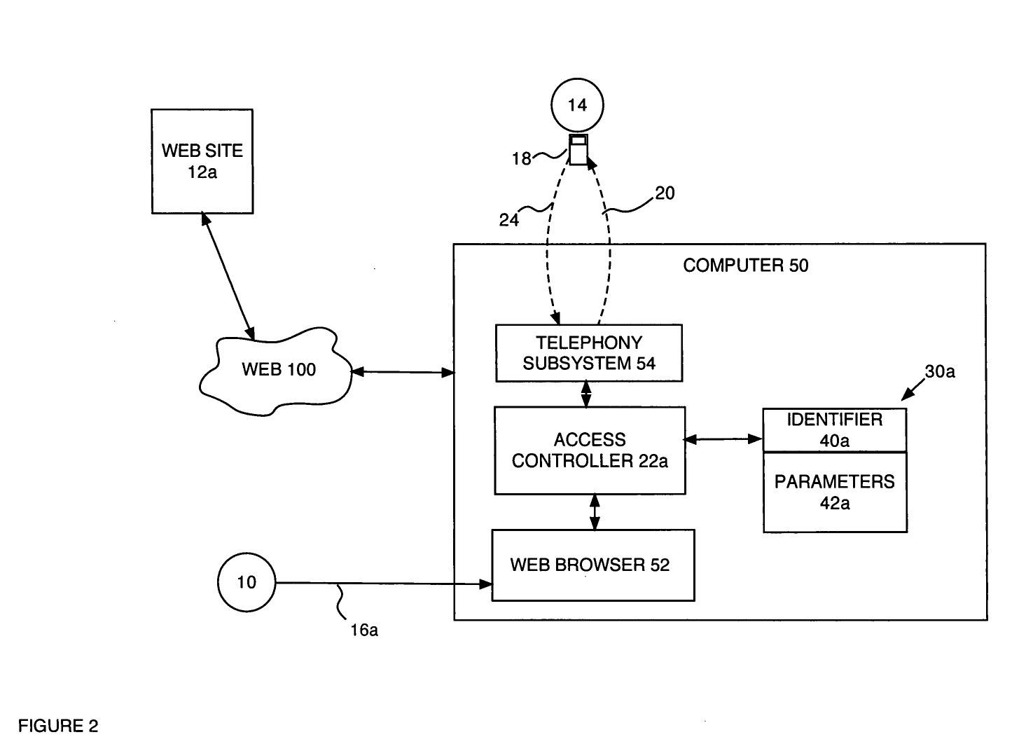

FIG. 2 shows an embodiment in which the object 12 is a web site 12a that is accessible via the (world-wide) web 100. The individual 10 makes an attempt 16a to access the web site 12a using a web browser 52 on a computer 50. The access controller 22 is implemented as an access controller 22a software which uses a telephony subsystem 54 of the computer 50 to place the communication 20 and obtain the control input 24. The access controller 22a intercepts the attempt 16a and performs the communication 20 to the third-party 14 and obtains the control input 24 from the third-party 14 and uses it to determine whether or not to allow the individual 10 to access the web site 12a in accordance with a set of settings 30a.

The third-party 14 may be a parent of the individual 10. The parent may configure their cell phone number as an identifier 40a and configure a web address of the web site 12a into the parameters 42a so that when the web address for the web site 12a is selected via the web browser 52 the access controller 22a in response calls the cell phone 18 to obtain approval from the parent. The parameters 42a may include a list of web sites, e.g. using URLs, that will prompt the access controller 22a to call the parent. The parameters 42a may specify hours of day which will prompt a call from the access controller 22 to the parent.

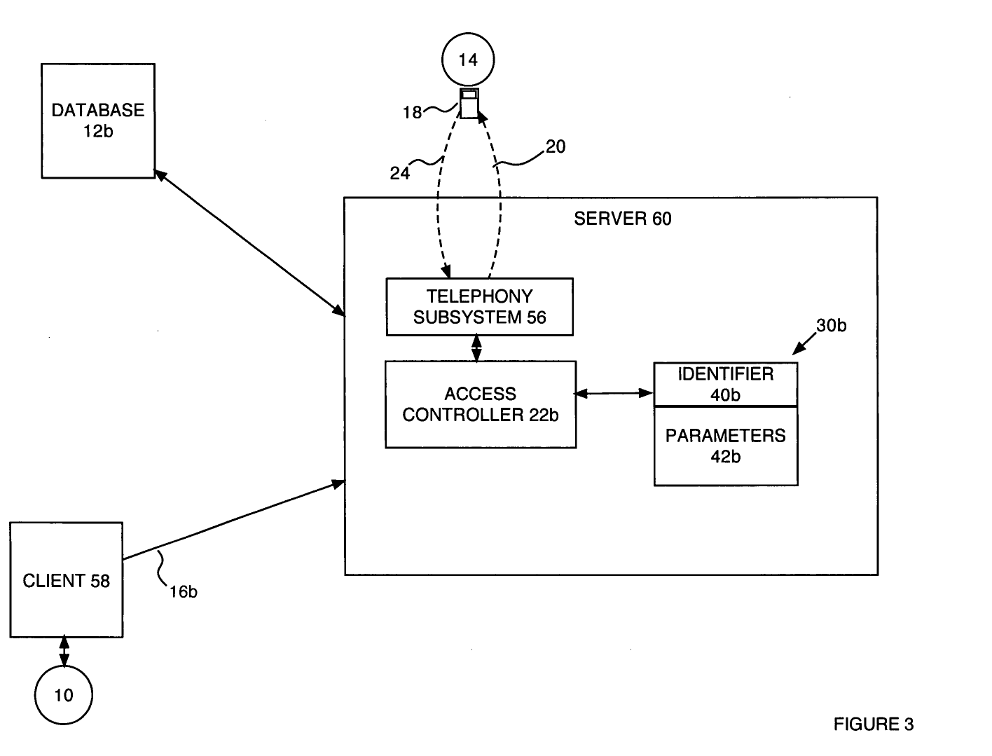

FIG. 3 shows an embodiment in which the object 12 is a database 12b and an access controller 22b is implemented in a server 60 for the database 12a. The individual 10 makes an attempt 16b to access the database 12b using a client 58 of the server 60. The access controller 22b uses a telephony subsystem 56 in the server 60 to place the communication 20 and obtain the control input 24. The access controller 22b intercepts the attempt 16b and performs the communication 20 to the third-party 14 and obtains the control input 24 from the third-party 14 and uses it to determine whether or not to allow the individual 10 to access the database 12b in accordance with a set of settings 30b.

The third-party 14 may be an official responsible for database security or an employer of the individual 10 whose telephone number is recorded as an identifier 40b. The parameters 42b may specify that any access to the database 12b by the individual 10 requires authorization or may specify a set of records of the database 12b that when accessed by the individual 10 require authorization. The parameters 42b may specify times of day that will require authorization by the third-party 42.

In yet another embodiment, the object 12 is a file on a computer or on a server and the access controller 22 is implemented in software on the computer or the server. The individual 10 may be a user of the computer or a client of the server. The third-party 14 may be an official responsible for file or computer system security or an employer of the individual 10 or a parent. The parameters 42 may includes a list of files that will prompt a call the third-party 14 when accessed by the individual 10.

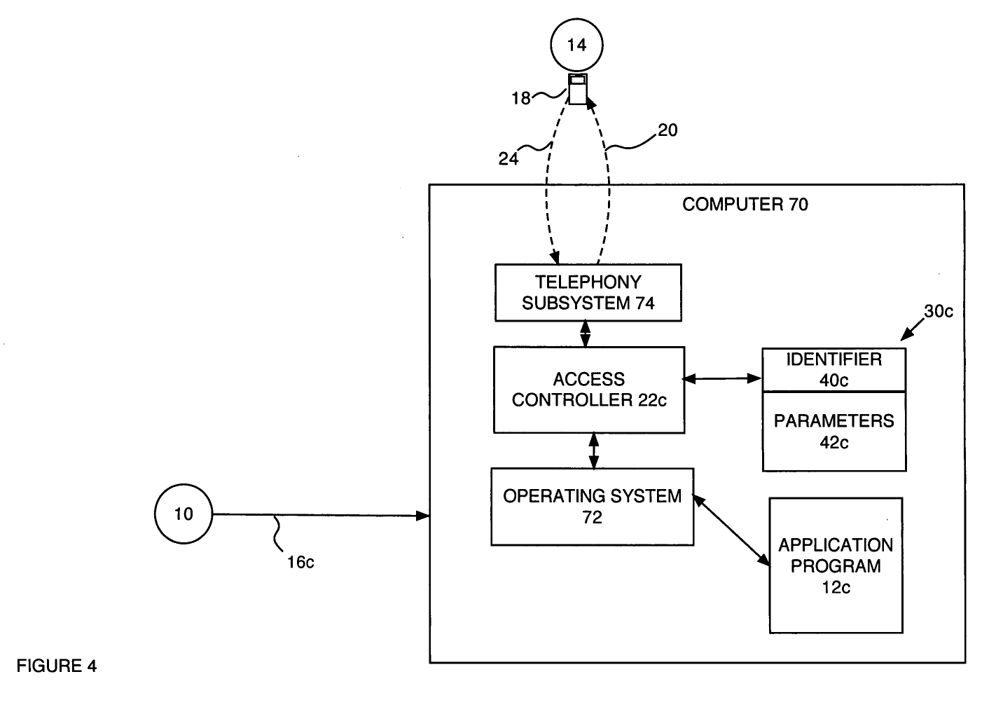

FIG. 4 shows an embodiment in which the object 12 is an application program 12c that runs under an operating system 72 of a computer 70. The individual 10 makes an attempt 16c to access the application program 12c via a user interface of the computer 70. An access controller 22c running in concert with the operating system 72 or as part of the operating system 72 uses a telephony subsystem 74 in the computer 70 to place the communication 20 and obtain the control input 24.

The access controller 22c uses the control input 24 to determine whether or not to allow the individual 10 to access the application program 12c in accordance with a set of settings 30c. A set of parameters 42c may specify a list of one or more application programs that will prompt the access controller 22c to call the third-party 14. The parameters 42c may specify a list of individuals, e.g. by login identifier, that will prompt the access controller 22c to call the third-party 14 in response to an attempt to access the application program 12c. The parameters 42c may specify hours of day, days of the week, etc. that will prompt the access controller 22c to call the third-party 14 in response to an attempt to access the application program 12c.

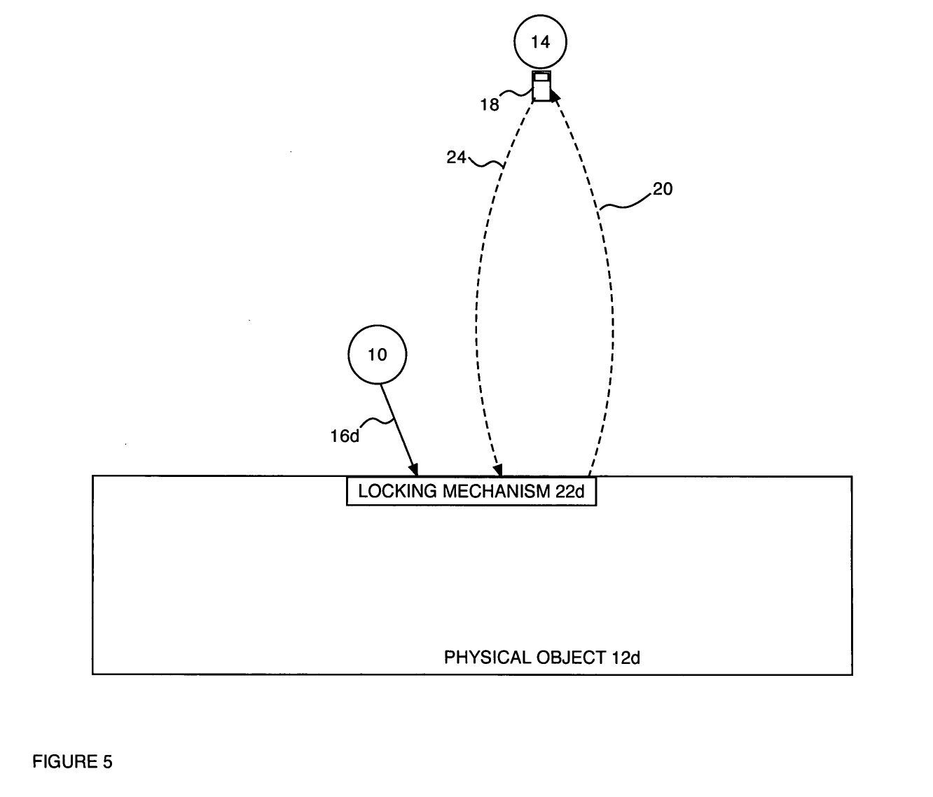

FIG. 5 shows an embodiment in which the object 12 is a physical object 12d, e.g. a secure building or a secure area within a building or some other physical enclosure or a vehicle. The access controller 22 and the settings 30 and a telephony subsystem are implemented in hardware/software in a locking mechanism 22d that controls access to the physical object 12d. The individual 10 makes an attempt 16d to access the physical object 12d by making an appropriate presentation at the locking mechanism 22d. For example, the locking mechanism 22d may accept key codes or security badges, etc. A vehicle may accept a key or a key code.

The settings 30 in the locking mechanism 22d may include a list of one or more individuals, e.g. by badge identifier, access code, etc., attempts by which will prompt the access controller 22 to call the third-party 14. The settings 30 may specify hours of day which will prompt a call to the individual 14. The third-party 14 for example may be an official responsible for security or an employer of the individual 10 or a parent of the individual 10.

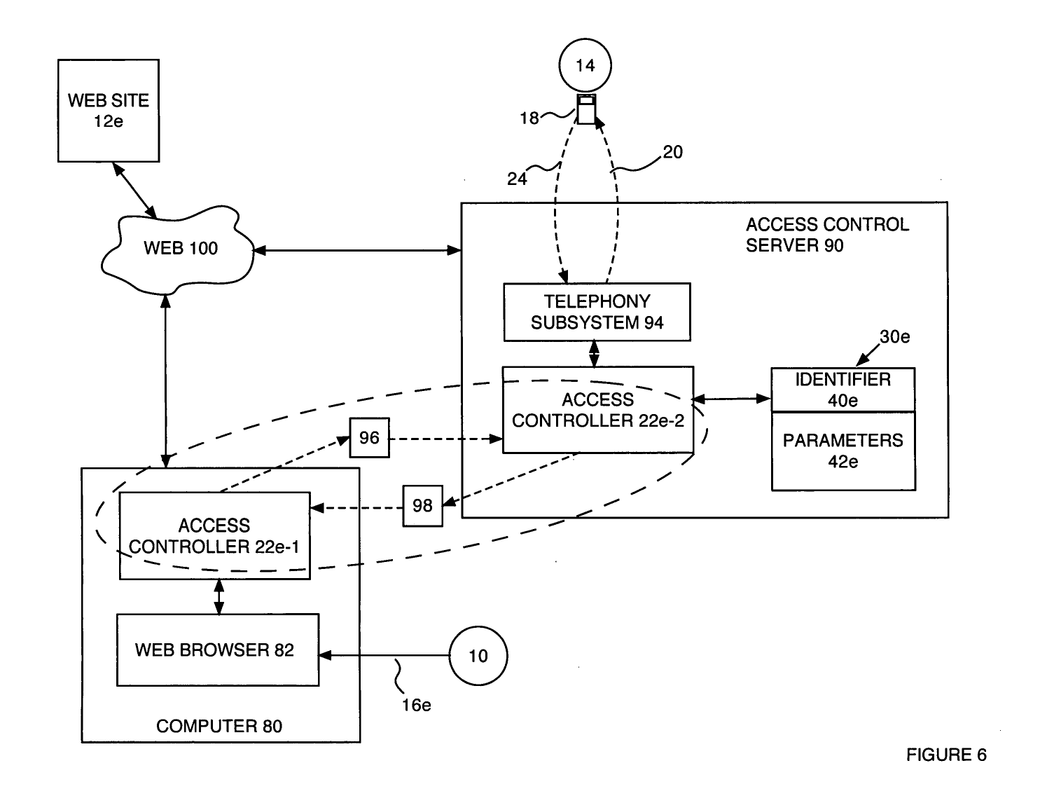

FIG. 6 shows an embodiment in which some of the functions of the access controller 22 are performed by an access control server 90. The individual 10 makes an attempt 16e to access a web site 12e using a web browser 82 on a computer 80. The access controller 22 functions are implemented as an access controller 22e-1 software running on the computer 80 and an access controller 22e-2 software running on the access control server 90. The access controller 22e-2 maintains a set of settings 30e on the access control server 90 and uses a telephony subsystem 94 in the access control server 90 to place the communication 20 and obtain the control input 24.

The access controller 22e-1 intercepts the attempt 16e and in response sends a request 96 to the access controller 22e-2. The request 96 includes a set of access parameters that describe the attempt 16e including, for example, an identification of the individual 10 and the web site 12e sought by the individual 10 and any other parameters that may be useful with respect to the parameters 42e. The access controller 22e-2 obtains authorization from the third-party 14 if the parameters 42e and the access parameters in the request 96 indicate that authorization from the third-party 14 is needed. The access controller 22e-2 responds to the request 96 by sending back a response 98 with an “access approved” indicator if the third-party 14 approved the attempt 16e or if authorization by the third-party 14 is not needed or with an “access denied” indicator if the third-party 14 refused to allow the attempt 16e to proceed. The access controller 22e-1 and the access controller 22e-2 may communicate via the web 100 using a client-server protocol.

The access control server 90 may provide authorization services for access controller 22 clients that control access to files, databases, application programs, physical structures, vehicles, etc. In some embodiments, the settings 30 may be maintained by a client of the access control server.

The foregoing detailed description of the present invention is provided for the purposes of illustration and is not intended to be exhaustive or to limit the invention to the precise embodiments disclosed. Accordingly, the scope of the present invention is defined by the appended claims.

What is claimed is:

1. A method for access control, comprising:
performing a communication to a third-party in response to an attempt by an individual to access an object;
obtaining a control input from the third-party using the communication;
determining whether to allow the individual to access the object in response to the control input.

2. The method of claim 1, wherein the object is a virtual object.

3. The method of claim 1, wherein the object is a physical object.

4. The method of claim 1, wherein the object is a physical structure.

5. The method of claim 1, wherein the object is a vehicle.

6. The method of claim 1, wherein performing a communication comprises placing a call to the third-party.

7. The method of claim 6, wherein placing a telephone call comprises placing a call to a handheld device belonging to the third-party.

8. The method of claim 1, wherein obtaining a control input comprises obtaining a password from the third-party.

9. A system for access control, comprising:
a set of settings by a third-party for controlling access to an object by an individual;
access controller that performs a communication to the third-party in response to an attempt by the individual to access the object and in response to the settings, the access controller obtaining a control input from the third-party using the communication and then determining whether to allow the individual to access the object in response to the control input.

10. The system of claim 9, wherein the settings specify a telephone number for a handheld device belonging to the third-party such that the access controller performs the communication using the telephone number.

11. The system of claim 9, wherein the settings specify a set of conditions that cause the access controller to perform the communication.

12. The system of claim 9, wherein the settings identify the individual so that the access controller can recognize the attempt.

13. The system of claim 9, wherein the settings identify the object so that the access controller can recognize the attempt.

14. The system of claim 9, wherein the access controller comprises;
client system used by the individual to make the attempt;
access control server having a subsystem for performing the communication.

15. The system of claim 14, wherein the client system sends a request to the access control server such that the request includes a set of access parameters that describe the attempt.

16. The system of claim 15, wherein the access control server determines whether to perform the communication in response to the settings and the access parameters.

17. The system of claim 15, wherein the access control server sends a response to the client system that specifies whether the attempt is approved.
